(19) United States
(12) Patent Application Publication
(10) Pub. No.: US 2015/0319112 A1
(43) Pub. Date: Nov. 5, 2015

(54) SUBSCRIPTION MANAGEMENT

(71) Applicant: Metaswitch Networks Limited, Enfield Middlesex (GB)

(72) Inventor: Alan Ross Cook, Enfield Middlesex (GB)

(73) Assignee: Metaswitch Networks Limited, Enfield Middlesex (GB)

(21) Appl. No.: 14/106,217

(22) Filed: Dec. 13, 2013

(51) Int. Cl. H04L 12/58; H04L 29/06; H04L 12/26

(52) U.S. Cl. CPC H04L 51/043; H04L 43/04; H04L 65/1006

(57) ABSTRACT

The invention relates to a method and apparatus for allowing presence information from multiple platforms to be synchronised to provide a single master presence status. This is achieved by a client monitoring the status on one platform and then updating the status on a different platform in response to changes.

### CROSS REFERENCE TO RELATED APPLICATIONS

Not Applicable.

### STATEMENT RE: FEDERALLY SPONSORED RESEARCH/DEVELOPMENT

Not Applicable.

There are a large number of communication methods available for one person to communicate with another. As part of this, it is often desirable for one user in a communication system to be able to see the presence state of another user system with who they may wish to communicate. Presence state generally refers to the communication status of a user which can be used to provide other users with an indication of the availability of a user to carry out communication. This presence state cm include a vast number of different statuses such as: available, busy, away, offline, etc. The status of a user may refer to an explicit status set by a user or be derived from the status of a group of devices or clients associated with a user. A user may have multiple statuses depending on which sub group of devices or systems are considered.

Using this information, a first user, user X can determine the status of another user, user Y, without actually initiating a communication. So, for example, if user Y is on a telephone call then their presence state may indicate that they are busy. User X would be able to use this presence state information to determine that there is no need to initiate a telephone call at this stage. This avoids having to actually dial user Y or obtaining an engaged tone. Similarly user X may wish to communicate with user Y using instant messaging (IM). The presence state of user Y on their IM client may indicate that they are available so that user X knows that they can initiate a messaging session.

A user may have a presence state on two different communication mechanisms. For example, user Y may have a presence state in relation to their IM status but also have a presence state in respect of their voice status, i.e. in respect of their telephone usage. In order for user X to establish the presence state of user Y, then they may need to establish the presence state over the two different mechanisms. User Y may have multiple devices connected to the same account over either of the communication mediums. Consequently, user Y may have a significant number of presence states corresponding to each device but it is desirable to have a single presence indicator for user Y. For example if user Y is sitting in front of a computer and has access to an IM client, then their IM status may be “available for chat”. If user Y then receives a telephone call on a SIP phone then their voice or phone status might be busy but their IM status may still show as available. furthermore, if user Y has a mobile phone with an IM client on it, that client may also indicate that it is available.

Therefore, in order for user X to determine the overall presence state of user Y, they may need to establish several different presence indicators over different mechanisms, such as IM or SIP. The devices of user Y which are providing an IM function can provide status information using XMPP (Extensible Messaging and Presence Protocol). Similarly, if user Y uses a voice (SIP) phone, which may be a softphone or a hardphone, the SIP connection status of the phones may be obtained using a SIP “SUBSCRIBE” message to determine the presence state of that device or the SIP account of user Y.

One solution is to use the XMPP connection to provide a single presence indicator for a user. FIG. 1 shows a typical arrangement for such a user with a hardphone Y₁ (such as a dedicated hardware SIP phone), a softphone Y₂ with a built in IM client, an IM client on a PC Y₃ and an IM client on a mobile phone Y₄. In this example, a client, such as the softphone may have a connection to both Internet Messaging over XMPP and voice channels using SIP. This would allow the softphone to publish presence changes to the XMPP server due to changes in the IM status and well changes to the SIP server due to changes in the SIP presence status. In contrast, the hardphone only has a SIP connection and no IM client or XMPP capability, and so the status of that phone may not be known or available to other clients (Y₂-Y₄) or the XMPP server.

Consequently, in the example above, the XMPP connection does not have a complete view of the presence information for user Y. Although the softphone can publish presence changes when SIP calls are made on the softphone itself, it is unaware of calls made on the hardphone. Equally, the SIP server does not have a complete view of the presence information. Although user X can subscribe to the presence state of user Y over SIP by issuing a SUBSCRIBE request to the status of user Y's account user X will not receive presence information made exclusively using the XMPP connection such as putting the IM status to do not disturb or status automatically changing to IDLE after a period of user inactivity.

One solution to the problem of user X wishing to see the status of user Y is to send a SIP subscribe message for user Y's SIP account to obtain user Y's SIP status and simultaneously maintain the XMPP connection to obtain XMPP presence information about user Y. Whilst this is not too onerous for a simple two person scenario, obtaining presence information when the number of users increases becomes significantly more challenging.

For example if user X wished to monitor the status of a number of friends then they would need to carry out separate monitoring activities for each of those friends. For the SIP connections, user X must subscribe to each friend's SIP status. Each individual SUBSCRIBE requires a separate session to be maintained, e.g. every 5 minutes each SUBSCRIBE (for each user monitored) must be re-sent, in order to keep the subscription active. To monitor the IM status of his friends, user X establishes an XMPP stream, which is permanently kept open. Any presence subscription sent within that stream remains active for the duration of the stream.

For example, as shown in FIG. 2, if user X wished to monitor N friends (Y₁-Y_{N}) then user X's client device must maintain N+1 active streams/dialogs to achieve this. This represent N SIP SUBSCRIBE commands and one active XMPP XML stream in order to maintain all the presence subscriptions. If each of the N friends of X also wished to maintain the status of user X and all the other N−1 people then they too would also requite N+1 active streams/dialogs. In a system where each user monitors every other user, it will be apparent that each additional user requires significant additional subscriptions to be maintained. In fact, the total number of subscriptions is roughly proportional to the square of the number of users or (N+1)² in the example above, as shown in FIG. 3.

It will therefore be apparent that as the number of users in the system increases, the number of subscriptions that need to be maintained may become very large as well as the overhead of serving all of the subscriptions over the network.

In the example above it is assumed that every user wishes to have presence information about each other user in the system. In reality this may not be true. However, even if each user only wishes to subscribe to presence information about a proportion of the other users, the number of active streams and dialogs still increases exponentially roughly proportional to N².

It is therefor an aim of the present invention to overcome or at least ameliorate some of the problems described above.

### SUMMARY OF THE INVENTION

According to the present invention there is provided a client for monitoring user presence status comprising: a SIP interface arranged to send a subscription message to a SIP server and to receive SIP status information relating to a SIP account associated with said user, from said SIP server; and an XMPP interface arranged to communicate with an XMPP server to provide status information based on said received SIP status information.

The invention allows a number of users to monitor the status of each other without the need to have an exponentially large number of SIP subscriptions in place. This allows the total number of actively maintained connections required to be significantly less than in the arrangement described above.

The SIP interface is preferably arranged to send a plurality of subscription messages, each subscription message relating to a respective SIP account associated with said user. This allows the user to have multiple SIP accounts but still maintain a single presence status which can be monitored using the invention.

One or more additional interfaces may be included, with each arranged to communicate with respective servers using respective communication protocols to obtain presence information relating to the user. Such additional interfaces can be used to provide the obtained presence information to the XMPP interface to provide status information to the XMPP server. This allows the invention to be used to consolidate presence information for various different domains in additional to SIP and XMPP. For example, one of the additional interfaces could be for communicating with a respective server using H.323.

The SIP interface may be further adapted to be able to receive a call identifier of an incoming call for the user in the SIP status information, and the XMPP interface can then communicate the call identifier to said XMPP server. This allows information about an incoming call for the user to be made available to other users to allow them to receive the call on their behalf. With the call identifier information, the SIP can be uniquely identified and the other user can take the SIP call on with it.

Preferably, the XMPP interface is further arranged to receive presence status information associated with the user from the XMPP server, and the SIP interface is further arranged to send update information to the SIP server based on the presence status information received fey the XMPP interface.

The present invention also provides a method for monitoring user presence status comprising: sending a subscription message to a SIP server; receiving SIP status information relating to a SIP account associated with said user from a SIP server; and providing status information to an XMPP server based on said received SIP status information.

The method may also include sending a plurality of subscription messages, each subscription message relating to a SIP account associated with the user. This allows a user to have multiple monitored SIP accounts.

The method may also include obtaining presence information relating to the user from one or more additional servers, using respective communication protocols; and providing status information to the XMPP server based on the obtained presence information. Preferably, at least one of the respective communication protocols is H.323.

The SIP status information may include a call identifier relating to an incoming call for the user and the call identifier may then be included in the status information provided to the XMPP server.

Preferably, the method also comprises receiving presence status information associated with the user from the XMPP server, and sending update information to the SIP server based on the presence status information received from the XMPP server.

The present invention further provides a system for monitoring user presence status comprising: a SIP server arranged to manage the status of a user SIP account; an XMPP server arranged to manage the status of a user XMPP account; and a user client, wherein said user client is arranged to: send a subscription message to said SIP server; receive SIP status information from said SIP server; and communicate with said XMPP server to provide status information based on said received SIP status information.

The user client may be arranged to send a plurality of subscription messages, each subscription message relating to a SIP account associated with the user.

The user client may be further arranged to communicate with one or more additional servers using respective communication protocols, to obtain presence information relating to the user, wherein the obtained presence information is used to provide status information to the XMPP server. At least one of the respective communication protocols may be H.323.

The SIP status information may include a call identifier relating to an incoming call for the user. The call identifier may then be included in the status information provided to the XMPP server.

The user client may be further arranged to receive presence status information associated with the user from the XMPP server, and the user client may be further arranged to send update information to the SIP server based on the presence status information received from the XMPP server.

The invention may additionally be implemented as computer executable code and the methods, systems and clients referred to above may be implemented as code on suitable devices, to provide the function of the present invention. In particular, the invention may provide a computer program product comprising computer executable code which when executed on a code executing device causes the device to: send a subscription message to a SIP server; receive SIP status information relating to a SIP account associated with said user from a SIP server; and provide status information to an XMPP server based on said received SIP status information.

### BRIEF DESCRIPTION OF THE DRAWINGS

The invention will now be described in more detail by reference to the non-limiting examples below and the figures in which:

FIG. 1 shows a simplified portion of a network in which users can monitor the presence status of each other;

FIG. 2 shows schematically the subscriptions required for a network of N+1 users;

FIG. 3 shows the relationship between a number of users in a system and the number of active streams/dialogs required to provide such monitoring;

FIG. 4 shows a comparison to a number of active streams/dialogs required according to the present invention;

FIG. 5 shows the basic communications used to maintain presence information required by a user; and

FIG. 6 shows a simplified portion of a network in which user X can monitor the presence status of user Y according to the invention.

### DETAILED DESCRIPTION OF THE INVENTION

In the example given above, the biggest proportion of the total number of dialogs required to maintain presence information was due to the need for users or user clients to obtain SIP status information for each other user that presence information is required for. In contrast, an XMPP subscription can receive presence updates for all contacts over one stream. As such, the XMPP connection is much more efficient at providing presence information. However, it is unable to directly provide information about a user's SIP status.

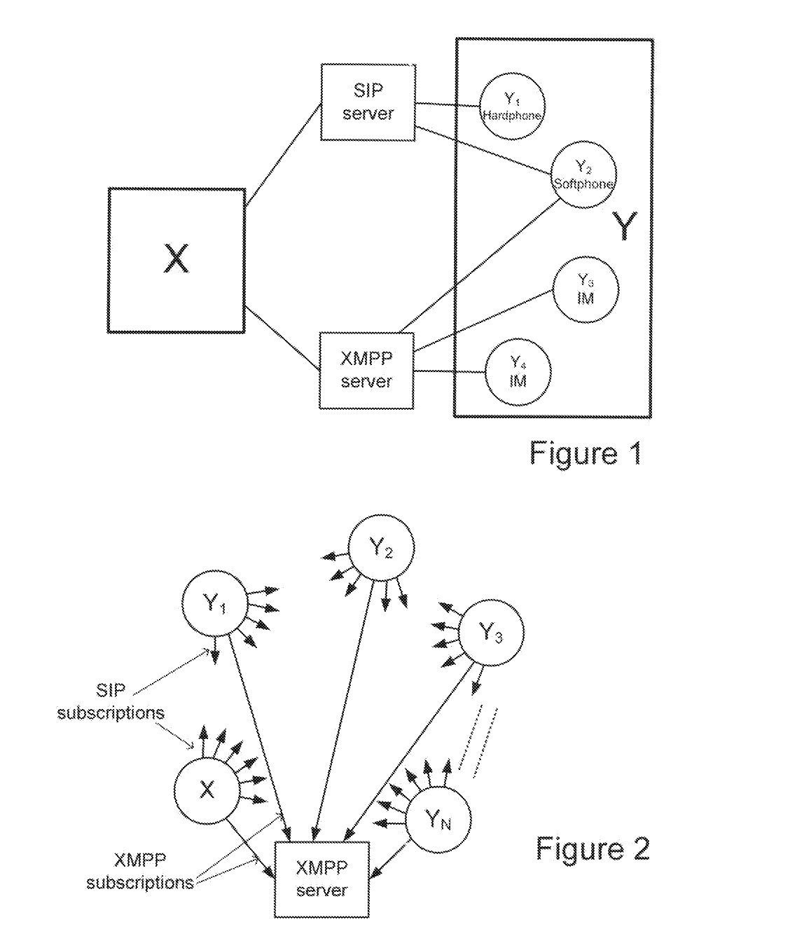

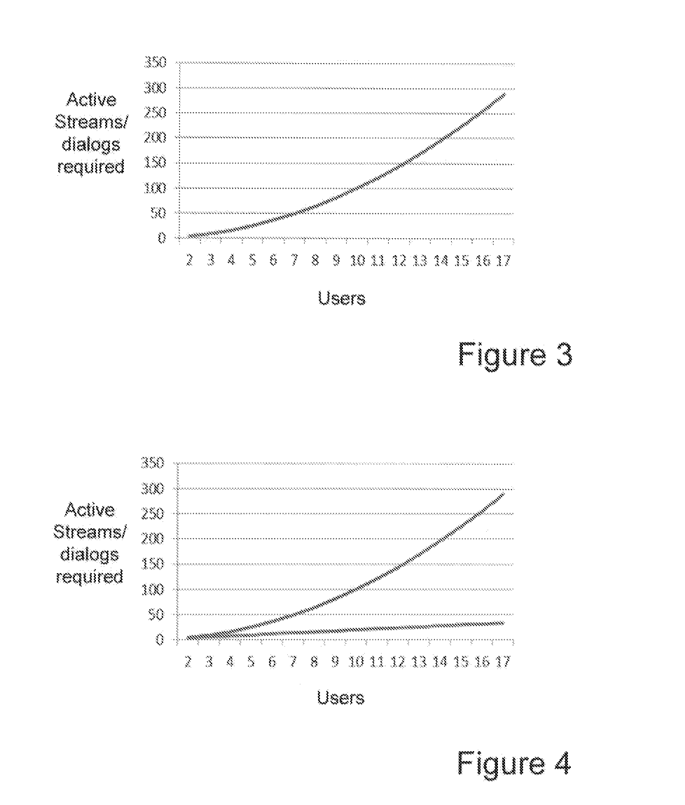

In the arrangement shown in FIG. 1, it is possible that the softphone Y₂ which, in the example, includes both an IM client as well as a SIP client, can provide IM status updates to the XMPP server based on SIP status updates. However, because Y₂ is not able to ascertain the status of the hardphone Y₁, the SIP status information provided to the XMPP server may only reflect changes in the status of the SIP connection of the softphone Y₂ and not correctly reflect changes in the status of the SIP hardphone Y₁.

In order to overcome this shortcoming, the softphone Y₂ can subscribe to the SIP presence state of user Y, in effect its own presence state, to accurately obtain the SIP status. The SIP protocol, allows for a SIP SUBSCRIBE message to be sent to the SIP server of a registrar for a SIP account. The SIP SUBSCRIBE message identifies the SIP account to be monitored and where any updates are to be sent (the subscriber). The SIP server will then monitor that account and if the status of the account changes, a response will be sent to the subscriber providing an indication of the updated SIP status.

Whilst this SIP SUBSCRIBE message is normally used for monitoring the status of another user's account, in this invention, hardphone Y₂ subscribes to its own SIP account status, or specifically the status of the account which Y₂ uses to obtain a SIP service. In this way, when a different client, such as hardphone Y₁, causes the SIP status to change, for example by initiating a phone call, the SIP server will alert the change in status and update Y₂ with this change.

Once softphone Y₂ has been provided with this information then it can use it to update the presence information of the SIP account to the XMPP server, over the existing XMPP XML stream (which is always connected). In this way, even though the hardphone Y₁ has no direct connection to the XMPP server. Its use of the SIP account can still be communicated to the XMPP server to update the presence information in respect of user Y. In this way, softphone Y₂ will effectively provide the SIP account status to the XMPP server, avoiding the need for other users to then determine the SIP status of user Y but instead being able to rely upon the presence master status provided by the XMPP server.

As can be seen from the lower line in FIG. 4, the number of active streams/dialogs required to monitor the status of the other users in the system is significantly reduced. This is particularly significant as the number of users increases because the rate at which the total number of active streams/dialogs increases is much less than with the example described above.

Referring to the arrangement in the example of FIG. 6, the detailed operation will now be described. Softphone Y₂ acts as the interface between tire SIP domain and the XMPP domain. The first stage is for Y₂ to establish itself as the monitoring device by indicating to the SIP server which manages user Y's SIP account that it wishes to be updated with my changes to the status of user Y's SIP account. This is achieved by sending a SIP SUBSCRIBE message (S1) to the SIP server of the SIP registrar that is hosting the SIP account for user Y. The SIP SUBSCRIBE message is received by the SIP server and indicates to the SIP server that softphone Y₂ is to be informed of any changes in the status of the SIP account of user Y.

As a precursor to this stage, softphone Y₂ may initially query the status of the SIP account to establish the initial state. This state information would then be communicated to the XMPP server to confirm or update the initial status information.

Once the SIP server has received a SIP SUBSCRIBE message. It will subsequently update any change in status of the SIP account to the address indicated in the SIP SUBSCRIBE message. In this case the address would relate to softphone Y₂. Consequently, when hardphone Y₁, or any other device or client wishing to initiate a call on the same SIP account, sends a SIP INVITE message (S2), the SIP server notes this request as a change of status of the SIP account of user Y. As a result the SIP server sends a SIP NOTIFY message back to softphone Y₂ indicating the change in presence state from, for example, phone idle to phone ringing. However, different statuses may be indicated for example “in call” or “do not disturb”. In the latter case, the change of a status may not be initiated by hardphone Y₁ making a call but instead simply updating the SIP server with its status.

The SIP NOTIFY message (S3) is received by softphone Y₂ which then needs to communicate the change in presence status of the SIP account to the XMPP server. The softphone Y₂ therefore sends a message to the XMPP server to pass on the change in SIP presence state and hence the new XMPP presence status to the XMPP server. In other words, the softphone Y₂ sends a <presence> stanza over the existing XMPP XML stream indicating a new status which is equivalent to the new SIP status.

On receipt of the new <presence> stanza over the XML steam, the XMPP server updates the current presence status of user Y. This changing status is then transmitted (S5) to user X's client X₁. In this example,, there are only two users, so the XMPP server only needs to rebroadcast the new presence information to user X, although it may also rebroadcast them to other clients that user Y has (e.g., Y₃, Y₄) which may need to be updated with a new XMPP status. However, in a system with multiple users, the new presence status for user Y may need to be communicated to a number of other users and their respective clients or devices, who may be interested in the presence status of user Y. This might be done by issuing a broadcast message relating to the status of user Y or fey sending update messages specifically to those users (or buddies) of user Y who would want to be made aware of the status of user Y.

It will be apparent that in the present invention, each user only has to maintain one SIP presence subscription for reflecting their own SIP presence state, and one XMPP XML stream. This is applicable even if they are monitoring the presence state of every available user within the system. It will therefore be apparent that for N users in a system, with all users wishing to monitor the presence status of all other users, then 2N active streams/dialogs would be required, in contrast to the (N+1)² required in the above example. Furthermore, each additional user only adds two additional streams/dialogs rather than N+1.

The foregoing embodiment relates to a system where a user has a subscription to a single XMPP connection and a single SIP connection. In both cases multiple devices or clients may be associated with the respective connection. In the example of FIG. 6, Y₂, Y₃ and Y₄ each include connections to one XMPP account whilst Y₁ and Y₂ both connect to a single SIP account. However, the present invention is equally applicable to arrangements where a user has additional subscriptions.

For example, the user may have two SIP connections and one XMPP connection. The arrangement of FIG. 6 may include a second hardphone Y₅ which connects to a different SIP account but equally Y₁ and/or Y₂ may simply have two SIP accounts through which they make calls. In this case, softphone Y₂ would subscribe to the presence state of both the first and the second SIP connections or accounts, even if it only uses one of the SIP accounts itself. In other words, it is not significant that softphone Y₂ might actually not establish calls using the second SIP connection. In fact, the softphone Y₂ may be replaced by a client which is not designed to provide any call functionality but is simply there to act as the interface between the SIP connection and the XMPP connection by issuing SIP SUBSCRIBE messages to obtain SIP status changes which it can then transmit to the XMPP server.

By subscribing to both SIP connections, softphone Y₂ would then be advised of any changes of such as due to telephone calls initiating from either account. Therefore, irrespective of which SIP account is used to initiate a call or change the status of a SIP account, the softphone Y₂ is updated so that it can then update the presence information on the XMPP server.

Again the embodiment above does not need to be limited to one or more SIP connections or XMPP connections. Instead it may also encompass connections to other protocols, such as H.323. Again the XMPP connection can be used as the master for presence information. A user client acting as an interface can obtain status information from one protocol such as SIP in the example above, but also from a different protocol such as H.323. The client can then update the master XMPP connection to provide an overall presence status for user Y over all three protocols.

In the above embodiment, simple presence information is communicated from the SIP server to the softphone Y₂ so that it may update the presence information on the XMPP connection. However, additional information may be provided such as the Call_ID for an active SIP call. This information could then be passed to the XMPP connection, in order for directed call pick-up to be invoked without the user needing to SIP SUBSCRIBE to the SIP presence information for each of their contacts. The SIP protocol allows one user to answer another call. This uses SIP line state monitoring (using SIP SUBSCRIBE).

For example, if one user (Y) wishes to answer calls for another user (X), Y SUBSCRIBES to the status of X. It is then possible for the server to be configured, such that if X receives an incoming call a NOTIFY message indicating the line presence change is sent to Y. This NOTIFY message includes a unique call identifier (call_ID) for the call that is alerting on X's phone. On receipt of the NOTIFY message, Y can answer the phone on behalf of X, for example by pressing a button with an indicator that X's phone is ringing. Y's phone will then send an INVITE message including a REPLACES header, in which the received call_ID is included, signalling that Y wants to ‘grab’ the call with the specified call ID. Y then effectively has answered the call on behalf of X. However, this does require user Y to SIP subscribe to the status of user X.

With the present invention, a user is able to receive a call for other users who are unable to accept a call for example, because they are already in a different call, without having to SIP subscribe to each user. By having the call_ID synchronized through the XMPP server, allowing the Call_ID to be made available in the presence information of the XMPP stream of a user, the invention provides the ability for other users to receive a call on behalf of that user.

So if user Y wishes to receive calls on behalf of user X, they can see if user X is ‘out of call’, ‘ringing’ or ‘in-call’. Then if a new call comes in for user X, user Y can obtain the call_ID through the XMPP server, just like the presence state. They can then take the call, as described above, by sending an INVITE message with a REPLACES header including the Call_ID.

In the above embodiment, the presence information is communicated from the SIP server to provide the SIP status to the XMPP connection to update the XMPP presence information. However, the XMPP presence information could be synchronised in the opposition direction such that the XMPP presence information is available to the SIP server. This kind of information can be used by the SIP server to make routing decisions, bused upon the presence information.

For example, if user Y has an XMPP only client such as the IM client Y₃ shown in FIG. 6, the user may update their overall presence status using this client only. The new presence information would be passed back to the XMPP server so that the XMPP presence information at the XMPP server could be updated. This would not be passed on to the SIP server directly by Y₃. However, passing this status information on to the SIP server allows the SIP server to utilise this information when routing calls to user Y. For example, if user Y sets their IM account status to DND (“Do not disturb”), using client Y₃, this status information would be passed to the XMPP server, which would then update the SIP status on the SIP server. This could be done directly or through the user client such as softphone Y₃ in the arrangement of FIG. 6.

In this way, when a call is subsequently received by the SIP server, the changed SIP status can be used to deal with the call appropriately. For example, if the user has updated their IM account status to DND causing the SIP server to be updated to the equivalent status, then the SIP registrar may respond to the incoming call by indicating that the user is “busy” or “unobtainable”. Alternatively, it may redirect the call according to some predefined rules relating to when user Y is not available (or has set their status to DND), such as directing the call to voicemail. Other rules may be used for different statuses. For example if the user bus set their IM status to “Away from office” then this will update the XMPP server status which can be relayed to the SIP server which sets the sip status accordingly. As a result, it may divert an incoming call to a mobile phone instead of to hardphone Y₁ and so on.

In this way, a user can change their status on an IM client, which may be on their mobile phone, and indirectly update their SIP status, even though they do not directly access any SIP enabled device.

As indicated above, the invention is not limited to using softphone Y₂ as the bridging device between the SIP connection and the XMPP connection. Any means for linking the two connections is sufficient. Any client or device may be used that is able to send SIP subscribe messages and receive SIP NOTIFY messages and use that information to update the XMPP server. Furthermore, the client may not be the only client of user Y which provides this service it is possible that multiple devices or clients associated with user Y provide the same service even though this may introduce replication. However, this ensures that if, for example, softphone Y₂ was provided on a laptop that was turned off, a further device would be able to directly update the XMPP server with changes in the presence status of the SIP account. Even if there was duplication in the update process, the end result should be the same. For example if a SIP call was initiated and two clients for user Y had subscribed with the SIP server to receive notification messages, then both will receive notification messages. In response, both clients would send update information to the XMPP server. The first update might change the status for user Y held by the XMPP server but the second message would have no effect as its indicated new status would already be set.

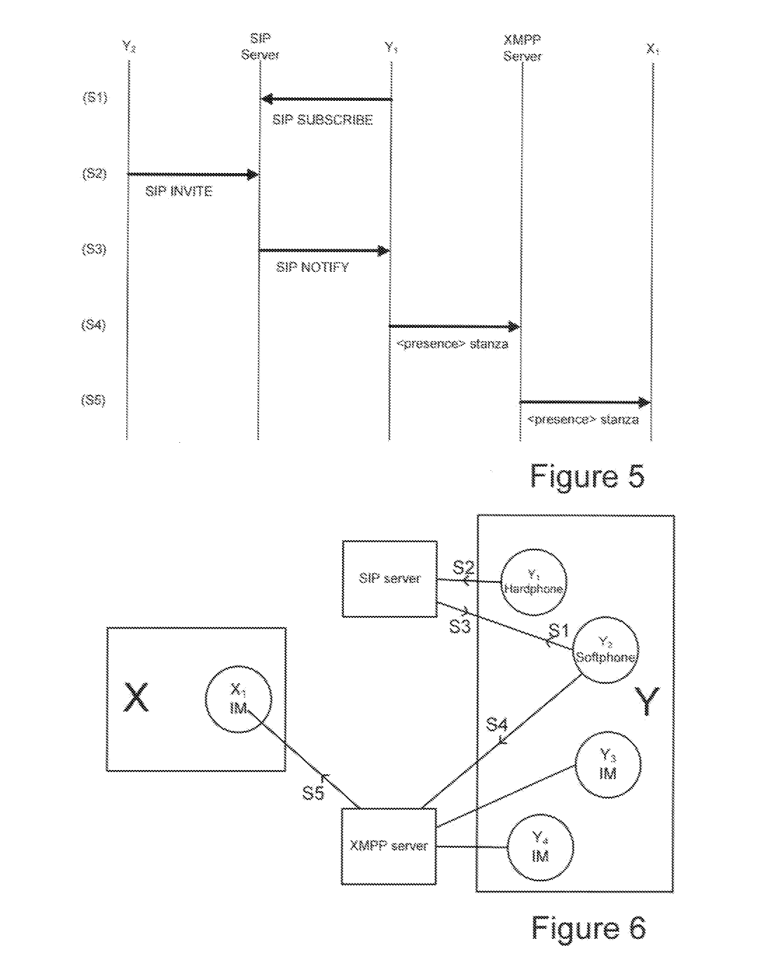

It should be noted that in FIG. 5 only the basic set of messages is shown and described. In accordance with SIP and XMPP standards as well as other standards, additional messages may be required by the respective protocols to complete the steps S1 to S5. However, these additional steps have been omitted for clarity.

The XMPP and SIP servers shown in FIGS. 2 and 6 are schematic and the messages may be passed through a number of intermediate steps before being received by the respective host server. Equally, different servers may be used especially where for example multiple SIP accounts are monitored.

The present invention may be implemented in any number of devices and is not intended to be limited to the examples above. For example, it may be implemented on a softphone; a hardphone; in a standalone client which has no user IM or SIP interface but simply acts as the intermediary between the SIP and XMPP domains; etc. The invention may also be implemented on a server, PC, smartphone, or any other similar or equivalent device. The implementing device may be a device which the user uses as a communication device such as a SIP phone or IM client, or may be a separate device which may even be remote from the user, for example hosted on a server in a different location.

References to H.323 in this document refer to the H.323 standard of the Telecommunication Standardization Sector of the ITU (International Telecommunication Union).

1. A client device for monitoring user presence status of a user, comprising:
a processor;
a SIP interface client embodied as a set of instructions executable by the processor and arranged to send a SIP subscribe message to a SIP server representing a request for SIP status information relating to a SIP account associated with said user for said client device, said SIP interface being receptive to said SIP status information transmitted from said SIP server as a SIP notify message in response to updates to said SIP status information on the SIP server; and
an XMPP interface client embodied as a set of instructions executable by the processor and arranged to communicate with an XMPP server to provide status information thereto for said client device in response to said SIP status information received by the SIP interface client.

2. A client device according to claim 1 wherein said SIP interface client is arranged to send a plurality of subscription messages, each subscription message relating to a respective SIP account associated with said user.

3. A client device according to claim 1 further comprising one or more additional interface clients, each arranged to communicate with respective servers using respective communication protocols to obtain presence information relating to said user, wherein said additional interfaces provide said obtained presence information to said XMPP interface to provide status information to said XMPP server.

4. A client device according to claim 3 wherein at least one of said additional interface clients communicates with a respective server using H.323.

5. A client device according to claim 1 wherein said SIP interface client is further arranged to receive a call identifier of an incoming call for said user in said SIP status information, and said XMPP interface client is further arranged to communicate said call identifier to said XMPP server.

6. A client device according to claim 1 wherein said XMPP interface client is further arranged to receive presence status information associated with said user from said XMPP server, and said SIP interface client is further arranged to send update information to said SIP server based on said presence status information received by said XMPP interface client.

7. A method for monitoring user presence status of a user, comprising:
sending a SIP subscribe message to a SIP server from a client, said SIP subscribe message representing a request by said client for SIP status information relating to a SIP account associated with said user for said client;
receiving a SIP notify message from said SIP server, said SIP notify message including said SIP status information relating to said SIP account associated with said user for said client upon said SIP status information being updated on said SIP server; and
in response to receiving said SIP notify message from said SIP server, providing status information to an XMPP server corresponding to said received SIP status information.

8. A method according to claim 7 further comprising sending a plurality of subscription messages, each subscription message relating to a SIP account associated with said user.

9. A method according to claim 7 further comprising:
obtaining presence information relating to said user from one or more additional servers, using respective communication protocols; and
providing status information to said XMPP server based on said obtained presence information.

10. A method according to claim 9 wherein at least one of said respective communication protocols is H.323.

11. A method according to claim 7, wherein said SIP status information includes a call identifier relating to an incoming call for said user, and said call identifier is included in said status information provided to said XMPP server.

12. A method according to claim 7 further comprising receiving presence status information associated with said user from said XMPP server, and sending update information to said SIP server based on said presence status information received from said XMPP server.

13. A system for monitoring user presence status of a user, comprising:
a SIP server arranged to manage the status of a user SIP account;
an XMPP server arranged to manage the status of a user XMPP account; and
a user client, wherein said user client is arranged to:
send a SIP subscribe message to said SIP server, said SIP subscribe message representing a request by said user client for said status of a user SIP account;
receive a SIP notify message from said SIP server, said SIP notify message including said SIP status information relating to said user SIP account associated with said user for said user client upon said SIP status information being updated on said SIP server; and
communicate with said XMPP server to provide status information corresponding to said received SIP status information in response to said SIP notify message.

14. A system according to claim 13 wherein said user client is arranged to send a plurality of subscription messages, each subscription message relating to a SIP account associated with said user.

15. A system according to claim 13 wherein said user client is further arranged to communicate with one or more additional servers using respective communication protocols, to obtain presence information relating to said user, wherein said obtained presence information is used to provide status information to said XMPP server.

16. A system according to claim 15 wherein at least one of said respective communication protocols is H.323.

17. A system according to claim 13, wherein said SIP status information includes a call identifier relating to an incoming call for said user, and said call identifier is included in said status information provided to said XMPP server.

18. A system according to claim 13 wherein said user client is further arranged to receive presence status information associated with said user from said XMPP server, and said user client is further arranged to send update information to said SIP server based on said presence status information received from said XMPP server.

19. A computer program product for monitoring user presence status of a user, the computer program product being embodied on a non-transitory storage medium and comprising computer executable code which when executed on a code executing device causes the device to:
send a SIP subscribe message to said SIP server, said SIP subscribe message representing a request by said user client for said status of a user SIP account;
receive a SIP notify message from said SIP server, said SIP notify message including said SIP status information relating to said user SIP account associated with said user for said user client upon said SIP status information being updated on said SIP server; and
provide status information to an XMPP server corresponding to said received SIP status information in response to said SIP notify message.
